(19) United States
(12) Patent Application Publication
(10) Pub. No.: US 2003/0084094 A1
(43) Pub. Date: May 1, 2003

(54) Method for transmitting state message in client-server-based networked virtual environment

(76) Inventors: Kwang-Hyun Shim, Daejeon (KR); Kwang-Ho Yang, Daejeon (KR); Il-Kyu Park, Daejeon (KR); Jong-Sung Kim, Daejeon (KR)

Correspondence Address: JACOBSON HOLMAN PLLC, 400 SEVENTH STREET N.W., SUITE 600, WASHINGTON, DC, 20004, US

(21) Appl. No.: 10/028,703

(22) Filed: Dec. 28, 2001

(30) Foreign Application Priority Data
Oct. 30, 2001 (KR) 2001-67068

(51) Int. Cl. G06F 15/16; G09G 5/00

(52) U.S. Cl. 709/203; 345/744

(57) ABSTRACT

Disclosed herein is a method for transmitting state information in a client-server based networked virtual environment in which a plurality of client computers are connected to a server computer through a network. The method includes the steps of measuring distances between a shared object and client avatars corresponding to the client computers in the client-server based networked virtual environment; and adjusting transmission rates of state renewal information from the server computer to the client computers according to the measured distances.

### FIELD OF THE INVENTION

The present invention relates generally to methods of transmitting state information in a client-server based networked virtual environment, and more particularly to a method for transmitting state information in a client-server based networked virtual environment, in which the transmission rate of state renewal information is directly or indirectly adjusted with the distance between a client and a shared object taken into consideration.

### BACKGROUND OF THE INVENTION

A networked virtual environment refers to a virtual space that is simulated by a computer on the basis of data distributed throughout a network. In the shared three-dimensional virtual space, participants freely move through the space, and interact with one another face-to-face or through the manipulation of a shared object. Networked virtual environment technology is applied to a variety of fields such as military simulation, joint design, cyber education, on-line games and so on.

A conventional networked virtual environment technology supports a small number of participants on the basis of peer-to-peer communication architecture. Currently, research is under way in which a networked virtual environment is constructed on the basis of a client-server architecture and supports participation and efficient interaction of several thousands or several tens of thousands of users.

As a result, in such a networked virtual environment, a server has to deal with several hundreds or several tens of thousands of clients, so excessive load is exerted on the network in this type of virtual environment. Of techniques for reducing such network overload, a dead reckoning algorithm and an Area-Of-Interest (AOI) management method are representative.

In the shared space of such a networked virtual environment, state messages should be transmitted to allow effective interaction between a plurality of participants, and data are preferably transmitted at every frame to maintain coherency in the states of the server and the client. These transmissions demand a sufficient network bandwidth, but this demand is not fulfilled in real situations. In particular, as the number of participants is increased, greater bandwidth is required.

Accordingly, a server generally samples the state renewal information of shared objects (including a client) periodically (using a period longer than the period of a frame) or occasionally and transmits the sampled state renewal information to clients, and the clients receive the transmitted state renewal information, renew the state information of shared objects and display it. As a result, when frames to which the state renewal information is not transmitted are present, objects are discontinuously moved in the virtual environment.

Accordingly, it is necessary to calculate the anticipated data of the frame to which the state renewal information is not transmitted, which can be implemented by the dead reckoning algorithm. In the dead reckoning algorithm, clients make predictions using state values and the latest variation rate on the basis of state information just received, and continuously displays predicted values. During this process, when new state information is received, the clients renew the state information of the shared objects and make prediction on the basis the renewed state information. Meanwhile, the server transmits state renewal information to the clients only when the difference between the actual state value of the shared object and the predicted state value thereof is greater than a certain threshold value. Such a threshold value is in inverse proportion to the transmission rate of state renewal information.

In the AOI management method, the entire virtual space of the networked virtual environment is divided into regions of uniform geometrical figure and state renewal information for a shared object is transmitted only to the clients situated in the regions (AOI regions) including the shared object.

An article entitled “Control mechanism for large-scale virtual environment” by Tain-Chi Lu, Journal of Visual Languages and Computing, Vol. 10, pp. 69-85, 1999, proposes a shared state control algorithm that supplements the dead reckoning algorithm.

In the proposed shared state control algorithm, an error about a shared state, which can be generated when the dead reckoning algorithm is employed, is minimized by transmitting all state renewal information to all users when the number of current participants is small; while network load is minimized by using the dead reckoning algorithm when the number of current participants is large. In brief, in the shared state control algorithm, the management of the shared state varies according to the number of participants, thus improving the entire performance.

In the meantime, in the dead reckoning algorithm and shared state control algorithm described above, the threshold value (in reverse proportion to the transmission rate of state renewal information) is fixed regardless of the distance between the shared object and the client, and in the AOI management method, state renewal information is transmitted at a fixed transmission rate regardless of the distance between the shared object and the client situated in a corresponding AOI region.

However, it is reasonable to transmit state renewal information more frequently to clients far away from a shared object than to clients near the shared object. The reason for this is that a shared object near a client frequently interacts with the client and a client can precisely learn the current state of a shared object by frequent reception of state messages and precisely interact with the shared object on the basis of the precise learning.

### SUMMARY OF THE INVENTION

Accordingly, the present invention has been made keeping in mind the above problems occurring in the prior art, and a general object of the present invention is to provide a method for transmitting state information in a client-server based networked virtual environment, which adjusts the transmission rate of state renewal information according to the distance between a client and a shared object, thereby reducing the entire transmission rate between the client and the server though preventing the client from experiencing a reduction in the quality of service and, consequently, allowing a given server to provide service to more clients.

A specific object of the present invention is to provide a method for transmitting state information in a client-server based networked virtual environment, which adjusts the period of event occurrence according to the distance between a shared object and a client, thereby directly adjusting the transmission rate of state renewal information.

Another specific object of the present invention is to provide a method for transmitting state information in a client-server based networked virtual environment, which adjusts a threshold value according to the distance between a shared object and a client, thereby indirectly adjusting the transmission rate of state renewal information.

In order to accomplish the above object, the present invention provides a method for transmitting state information in a client-server based networked virtual environment in which a plurality of client computers are connected to a server computer through a network, comprising the steps of: measuring distances between a shared object and client avatars corresponding to the client computers in the client-server based networked virtual environment; and adjusting transmission rates of state renewal information from the server computer to the client computers according to the measured distances.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is view showing architecture of a client-server based network system to which a method of the present invention can be applied;

FIG. 2 is a diagram showing a concept of the networked virtual environment on the network system of FIG. 1;

FIGS. 3a and 3b are flowcharts showing a method for transmitting state information in a client-server based networked virtual environment in accordance with a first embodiment of the present invention; and

FIGS. 4a and 4b are flowcharts showing a method for transmitting state information in a client-server based networked virtual environment in accordance with a second embodiment of the present invention.

### DETAILED DESCRIPTION OF THE PREFERRED EMBODIMENTS

Hereinafter, a method for transmitting state information in a client-server based networked virtual environment in accordance with the present invention is described with reference to the accompanying drawings.

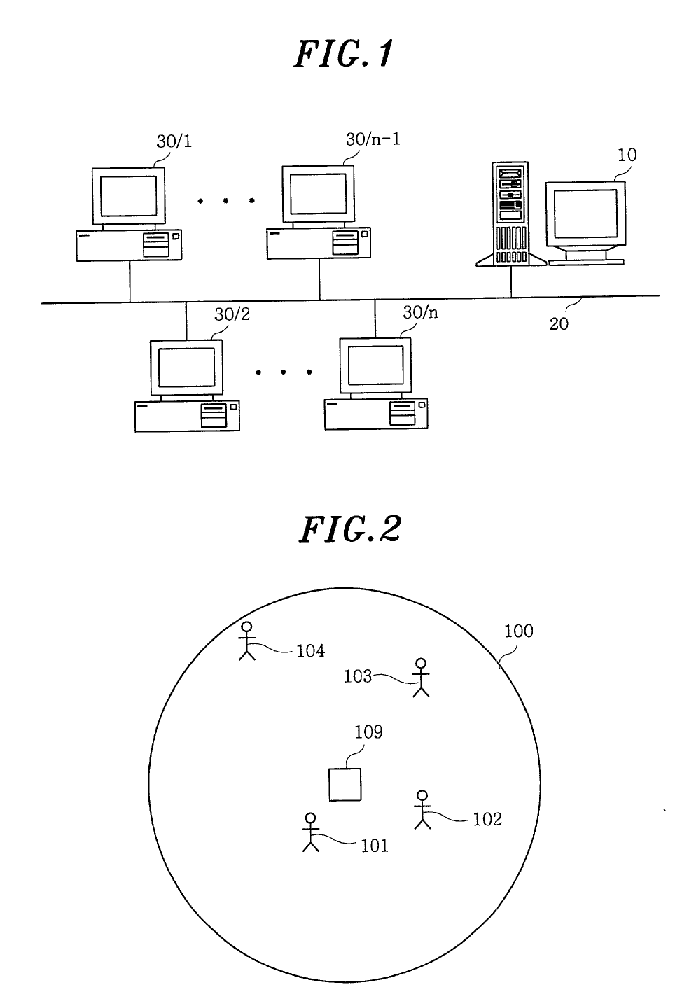

FIG. 1 is view showing architecture of a client-server based network system to which the method of the present invention can be applied. FIG. 2 is a diagram showing a concept of the networked virtual environment on the network system of FIG. 1.

A plurality of client computers 30/1 to 30/n are connected to a server computer 10 through a network 20. In this case, the client computers 30/1 to 30/n are represented as client avatars 101 to 104, or virtual objects in a virtual environment 100. Reference numeral 109 designates a shared object. The client avatars 101 to 104 interact with one another face-to-face or through the manipulation of the shared object 109.

Communication traffic generated on the client-server based network system is classified into state messages, event messages and session messages. The state messages are used for the clients to notify other clients of their states. The event messages are used to announce an action performed by a client. The session messages are generated when a client accesses or leaves the network based virtual environment. Of these messages, the state messages occupy most of traffic because they are periodically or occasionally transmitted. As a client receives more state messages, it more precisely learns the current state of the other clients. Accordingly, the client precisely interacts with the other clients, but consumes the more bandwidth in the network.

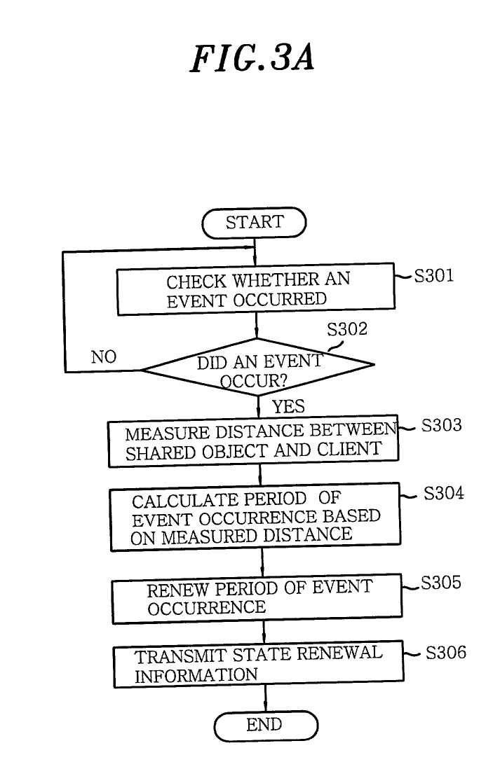

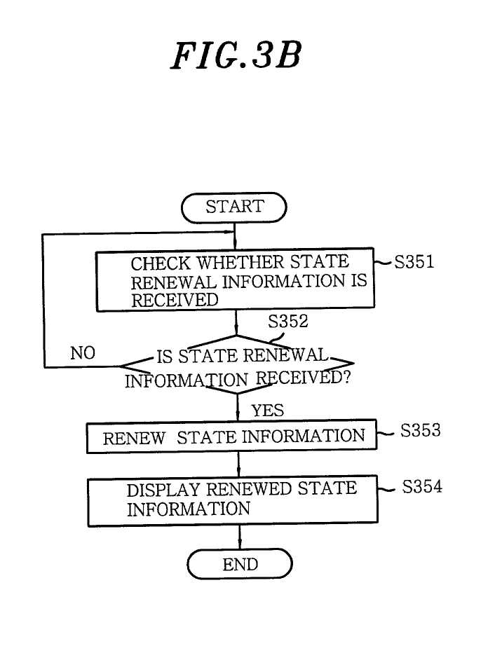

FIGS. 3a and 3b are flowcharts showing a method for transmitting state information in a client-server based networked virtual environment in accordance with a first embodiment of the present invention. FIG. 3a is a flowchart of a detailed process performed in the server computer. FIG. 3b is a flowchart of a detailed process performed in the client computer.

First, the server computer 10 determines whether an event occurs by periodically checking a timer for generating event messages (S301 to S302).

If an event message is generated, the distance between a corresponding client avatar and the shared object 109 is measured using coordinate values. On the other hand, if an event message is not generated, the generation of the event message is checked using the timer (S303).

The period of generation of an event is calculated on the basis of the measured distance, and the old period of the generation of an event of the timer is replaced by the calculated period (S304 to S305).

Thereafter, state renewal information is transmitted to a corresponding client computer through the network 20 (S306).

In this case, as the distance between the client avatar 101, 102, 103 or 104 and the shared object 109 is decreased, the period of the occurrence of an event is adjusted to be shorter. Accordingly, the transmission rate of state renewal information is in inverse proportion to the period of the occurrence of an event, so the transmission rate of the corresponding client avatar is increased.

For example, when four client avatars 101 to 104 are present in the virtual environment 100 and the distances between the client avatars 101, 102, 103 and 104 and the shared object 109 are as described in Equation 1, the periods of the occurrence of an event are also adjusted as described in Equation 1.

PeriodOfEventₐᵥₐₜₐᵣ₁₀₁<PeriodOfEventₐᵥₐₜₐᵣ₁₀₂<PeriodOfEventₐᵥₐₜₐᵣ₁₀₃<PeriodOfEventₐᵥₐₜₐᵣ₁₀₄ Equation (1)

where PeriodOfEventₐᵥₐₜₐᵣ₁₀₁, PeriodOfEventₐᵥₐₜₐᵣ₁₀₂, PeriodOfEventₐᵥₐₜₐᵣ₁₀₃ and PeriodOfEventₐᵥₐₜₐᵣ₁₀₄ are periods of the occurrence of an event for client avatars 101, 102, 103 and 104, respectively.

Accordingly, the transmission rates of state renewal information are as described as in Equation 2.

TransmissionRateₐᵥₐₜₐᵣ₁₀₁>TransmissionRateₐᵥₐₜₐᵣ₁₀₂>TransmissionRateₐᵥₐₜₐᵣ₁₀₃>TransmissionRateₐᵥₐₜₐᵣ₁₀₄ Equation (2)

where TranismissionRateₐᵥₐₜₐᵣ₁₀₁, TransmissionRateₐᵥₐₜₐᵣ₁₀₂, TransmissionRateₐᵥₐₜₐᵣ₁₀₃ and TransmissionRateaₐᵥₐₜₐᵣ₁₀₄ are the transmission rates of state renewal information for client avatars 101, 102, 103 and 104, respectively.

In the meantime, the client computers 30/1 to 30/n checks whether state renewal information is received from the server computer 20 (S351). If state renewal information is received, the client computers 30/1 to 30/n renew state information; while if state renewal information is not received, the client computers 30/1 to 30/n checks whether state renewal information is received from the server computer 20 (S352 to S353).

Thereafter, the renewed state information is displayed to the clients 30/1 to 30/n (for example, by means of graphs, three-dimensional objects, figures or the like) (S354).

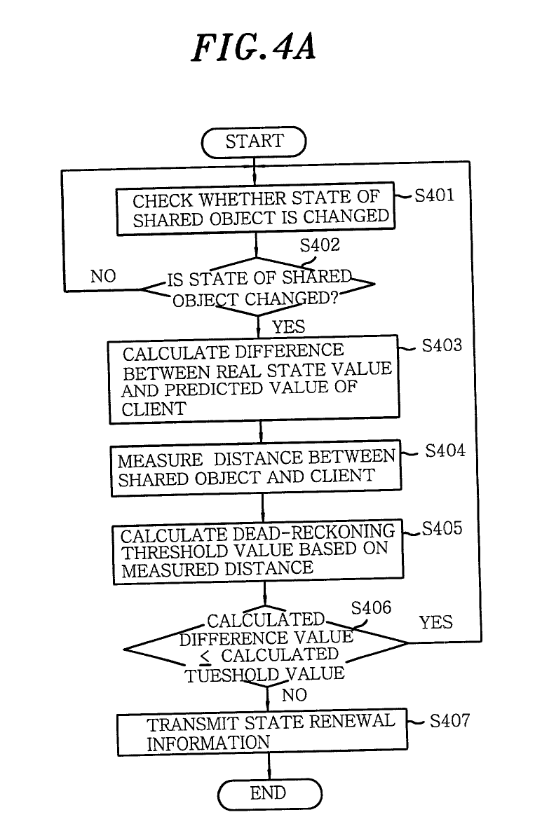

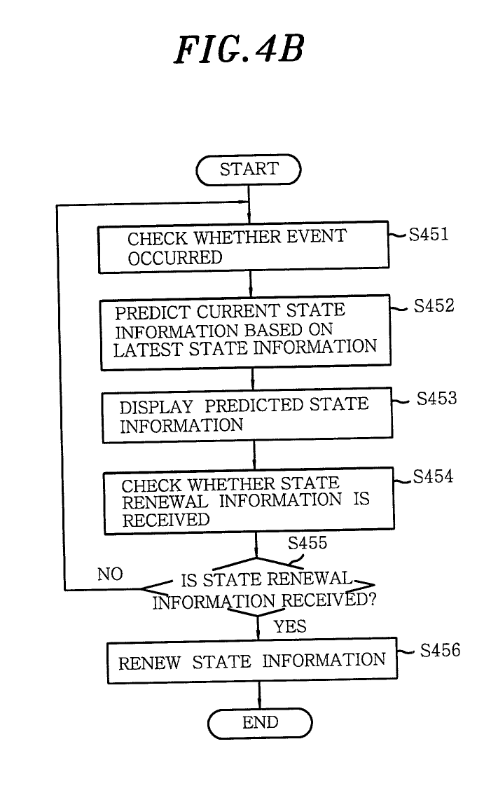

FIGS. 4a and 4b are flowcharts explaining a method for transmitting state information in a client-server based networked virtual environment. FIG. 4a is a flowchart of a detailed process performed in the server computer. FIG. 4b is a flowchart of a detailed process performed in the client computer.

First, the server computer checks whether the shared object 109 is varied in state (S401). If the shared object 109 is varied in state, the server computer calculates an error value between a varied actual state value and a value predicted by a corresponding client computer (S402 and S403).

Additionally, the distance between the shared object 109 and a corresponding client avatar is measured using coordinate values, and a dead reckoning threshold value is calculated with the measured distance taken into account (S401 to S403).

The server computer compares the calculated error value with the calculated threshold value (S406). If the calculated error value is greater than the calculated threshold value, the server computer transmits current state information (state value and the variation of state value), that is, state renewal information, to a corresponding client computer; while if the calculated error value is greater than the calculated threshold value, the process proceeds to step S401 and it is checked whether the shared object 109 is varied in its state (S406 to S407).

In this case, as the distance between the client avatar 101, 102, 103 or 104 and the shared object 109 is decreased, the dead reckoning threshold value is adjusted to be smaller. Accordingly, the transmission rate of state renewal information is in inverse proportion to the period of the occurrence of an event, so the transmission rate of the corresponding client avatar is increased.

For example, when four client avatars 101 to 104 are present in the virtual environment 100 and the distances between the client avatars 101, 102, 103 and 104 and the shared object 109 are as described in Equation 3, the periods of occurrence of an event are adjusted as described in Equation 1. Accordingly, the transmission rates of state renewal information are as described as in Equation 4.

Distanceₐᵥₐₜₐᵣ₁₀₁<Distanceₐᵥₐₜₐᵣ₁₀₂<Distanceₐᵥₐₜₐᵣ₁₀₃<Distanceₐᵥₐₜₐᵣ₁₀₄ Equation (3)

where Distanceₐᵥₐₜₐᵣ₁₀₁, Distanceₐᵥₐₜₐᵣ₁₀₂, Distanceₐᵥₐₜₐᵣ₁₀₁ and Distanceₐᵥₐₜₐᵣ₁₀₁ are the distances between the client avatars 101, 102, 103 and 104 and the shared object 109, respectively.

TransmissionRateₐᵥₐₜₐᵣ₁₀₁>TransmissionRateₐᵥₐₜₐᵣ₁₀₂>TransmissionRateₐᵥₐₜₐᵣ₁₀₃>TransmissionRateₐᵥₐₜₐᵣ₁₀₄ Equation (4)

where TransmissionRateₐᵥₐₜₐᵣ₁₀₁, TransmissionRateₐᵥₐₜₐᵣ₁₀₂, TransmissionRateₐᵥₐₜₐᵣ₁₀₃ and TransmissionRateₐᵥₐₜₐᵣ₁₀₄ are the transmission rates of state renewal information for client avatars 101, 102, 103 and 104, respectively.

In the meantime, the client computers 30/1 to 30/n determine whether an event occurs by periodically checking the timer for generating event messages. If an event message is generated, a current state value is predicted by the dead reckoning algorithm on the basis of the latest state information just received from the server computer 10 (S451 to S452).

Thereafter, the state value predicted by the dead reckoning algorithm is displayed to the clients 30/1 to 30/n (for example, by means of graphs, three-dimensional objects, figures or the like), and it is checked whether state renewal information arrives from the server computer 10 (S453 to S454).

If state renewal information arrives from the server computer 10, the state information of the shared object 109 that the client computers 30/1 to 30/n have is replaced by state information newly received; while if the state renewal information does not arrive from the server computer 10, the process returns to step S451, where it is determined whether an event occurs by periodically checking the timer (S455 to S456).

As described above, the present invention provides a method for transmitting state information in a client-server based networked virtual environment, in which the transmission rate of state renewal information is adjusted to be equal to the conventional transmission rate for clients near a shared object and to be smaller than the conventional transmission rate for clients away from the shared object, thereby reducing the entire transmission rate between the client and the server though preventing the client from experiencing a reduction in the quality of service and, consequently, allowing a given server to provide service to more clients.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for transmitting state information in a client-server based networked virtual environment in which a plurality of client computers are connected to a server computer through a network, comprising the steps of:
measuring distances between a shared object and client avatars corresponding to the client computers in the client-server based networked virtual environment; and
adjusting transmission rates of state renewal information from the server computer to the client computers according to the measured distances.

2. The method of claim 1, wherein said distance measuring step is selectively performed according to a result of determination after determining whether an event occurs by periodically checking a timer for generating an event message,
further comprising the step of transmitting state renewal information to the client computers through the network on the basis of the adjusted transmission rate.

3. The method of claim 1, wherein said transmission rate adjusting step comprises the steps of,
calculating periods of occurrence of an event of the timer on the basis of the measured distances, and
replacing a period of occurrence of an event of the timer with the calculated periods.

4. The method of claim 3, wherein said event occurrence period calculating step is performed in such a way that as the measured distance is decreased, the period of occurrence of an event is calculated to be shorter, thereby increasing the transmission rate of state renewal information for the corresponding client avatar.

5. A method for transmitting state information in a client-server based networked virtual environment in which a plurality of client computers are connected to a server computer through a network, comprising the steps of:
checking whether a shared object varies in its state, and calculating an error value between a varied actual state value and a value predicted by a corresponding client computer if the shared object is varied in state;
measuring a distance between the shared object and a client avatar corresponding to the client computer using coordinate values;
calculating a dead reckoning threshold value with the measured distance taken into account; and
comparing the calculated error value with the calculated threshold value, and selectively transmitting state renewal information according to a result of the comparison.

6. The method of claim 5, wherein said threshold value calculating step is performed in such a way that as the measured distance is decreased, the threshold value is calculated to be smaller, thereby increasing the transmission rate of state renewal information for the corresponding client avatar.
